(19) United States
(12) Patent Application Publication
(10) Pub. No.: US 2009/0153051 A1
(43) Pub. Date: Jun. 18, 2009

(54) PLASMA DISPLAY PANEL

(76) Inventors: Yun-Tae Hwang, Yongin-si (KR); Hyo-Suk Lee, Yongin-si (KR); Jae-Hyung Kim, Yongin-si (KR)

Correspondence Address: CHRISTIE, PARKER & HALE, LLP, PO BOX 7068, PASADENA, CA, 91109-7068, US

(21) Appl. No.: 12/116,544

(22) Filed: May 7, 2008

(30) Foreign Application Priority Data
Dec. 14, 2007 (KR) 10-2007-0131585

(51) Int. Cl. H01J 17/49

(52) U.S. Cl. 313/584

(57) ABSTRACT

A plasma display panel (PDP) for suppressing a chemical reaction between Na₂O components of a sodalime glass substrate and silver (Ag) components of electrodes. The PDP includes a first substrate; a second substrate facing the first substrate; a barrier rib between the first substrate and the second substrate to partition a plurality of discharge cells; a plurality of phosphor layers in the discharge cells; a plurality of address electrodes extending in a first direction on the first substrate; and a plurality of display electrodes extending in a second direction crossing the first direction on the second substrate. Here, at least one substrate of the first substrate or the second substrate includes sodalime glass including Na₂O, and at least one electrode of the address electrodes or the display electrodes on the at least one substrate includes silver (Ag) and a metal selected from a group consisting of copper (Cu), nickel (Ni), aluminum (Al), and combinations thereof.

### CROSS-REFERENCE TO RELATED APPLICATION

This application claims priority to and the benefit of Korean Patent Application No. 10-2007-0131585, filed in the Korean Intellectual Property Office on Dec. 14, 2007, the entire content of which is incorporated herein by reference.

### BACKGROUND OF THE INVENTION

1. Field of the Invention

The present invention relates to a plasma display panel (PDP). More particularly, the present invention relates to a plasma display panel (PDP) for suppressing (or reducing) a chemical reaction between a sodalime glass substrate and an electrode.

2. Description of the Related Art

A plasma display panel (PDP) is a display device for realizing an image by gas discharge. That is, the gas discharge generates plasma, the plasma radiates vacuum ultraviolet (VUV) rays, the VUV rays excite phosphors, and the excited phosphors are stabilized to generate red (R), green (G), and blue (B) visible light.

For example, in an alternating current (AC) PDP, address electrodes are formed on a rear substrate, and a dielectric layer is formed on the rear substrate while covering the address electrodes. Barrier ribs are formed in a stripe pattern on the dielectric layer between the respective address electrodes. Red (R), green (G), and blue (B) phosphor layers are formed on inner surfaces of the barrier ribs and on a surface of the dielectric layer.

Display electrodes (e.g., a sustain electrode and a scan electrode formed in pairs) are formed on a front substrate extending in a direction crossing the address electrodes. A dielectric layer and a MgO protective layer are accumulated on an inner surface of the front substrate while covering the display electrodes.

Discharge cells are partitioned by the barrier ribs, and are formed at crossing regions of the address electrodes and the display electrodes. Accordingly, millions (or more) of the discharge cells can be arranged in a matrix structure in the PDP.

To reduce the manufacturing cost of the PDP, the front substrate and the rear substrate may be formed of a sodalime glass including Na₂O. To improve electrical conductivity, the address electrodes and the display electrodes may include silver (Ag).

When the sodalime glass is used as the rear substrate, a migration problem may occur that is caused by a chemical reaction between Na₂O components of the sodalime glass and the silver components of the address electrodes. Accordingly, the address electrodes are short-circuited, and vertical line defects are generated.

When the sodalime glass is used as the front substrate, a migration problem may be caused by a chemical reaction between Na₂O components of the sodalime glass and the silver components of bus electrodes of the display electrodes. Thereby, the color of the front substrate may be changed, resulting in yellowing of the front substrate.

To suppress (or protect from) the above problems, SiO₂ thin films are formed on the rear substrate and the front substrate and the address electrodes and the bus electrodes are formed on the SiO₂ thin films. As such, additional processes for forming the SiO₂ thin films are performed, and the manufacturing cost of the plasma display panel increases. Thus, there is a need to simplify the manufacturing process and reduce the manufacturing cost of the plasma display panel.

The above information disclosed in this Background section is only for enhancement of understanding of the background of the invention and therefore it may contain information that does not form the prior art that is already known in this country to a person of ordinary skill in the art.

### SUMMARY OF THE INVENTION

Aspects of embodiments of the present invention are directed toward a plasma display panel for suppressing (or reducing) a chemical reaction between Na₂O components of a sodalime glass substrate and silver components of electrodes, and/or for simplifying a manufacturing process of the plasma display panel and reducing a manufacturing cost of the plasma display panel.

In addition, aspects of embodiments of the present invention are directed toward a plasma display panel for suppressing (or reducing) a chemical reaction between Na₂O components of a rear substrate including a sodalime glass and silver components of address electrodes, and/or for preventing (or reducing) vertical lines defects generated by a short-circuit of the address electrodes.

Further, aspects of embodiments of the present invention are directed toward a plasma display panel for suppressing (or reducing) a chemical reaction between Na₂O components of a front substrate including a sodalime glass and silver components of bus electrodes, and/or preventing (or reducing) yellowing generated by a color change of the front substrate.

An exemplary embodiment of the present invention provides a plasma display panel that includes a first substrate; a second substrate facing the first substrate; a barrier rib between the first substrate and the second substrate to partition a plurality of discharge cells; a plurality of phosphor layers in the discharge cells; a plurality of address electrodes extending in a first direction on the first substrate; and a plurality of display electrodes extending in a second direction crossing the first direction on the second substrate. Here, at least one substrate of the first substrate or the second substrate includes sodalime glass including Na₂O, and at least one electrode of the address electrodes or the display electrodes on the at least one substrate includes silver (Ag) and a metal selected from a group consisting of copper (Cu), nickel (Ni), aluminum (Al), and combinations thereof.

In one embodiment, the silver and the metal form an alloy.

In one embodiment, the at least one electrode further includes a frit attached to the at least one substrate.

In one embodiment, the silver is formed as silver particles, the metal is formed as metal particles in the at least one electrode, and the silver particles are covered with the metal particles. Here, the metal particles may be smaller than the silver particles and may be attached to surfaces of the silver particles, and the at least one electrode may further include a frit attached to the at least one substrate.

Another exemplary embodiment of the present invention provides a plasma display panel that includes a first substrate including sodalime glass, the sodalime glass including Na₂O; a plurality of address electrodes extending in a first direction on the first substrate and covered with a dielectric layer; a barrier rib for partitioning a plurality of discharge cells on the dielectric layer; a plurality of phosphor layers in the discharge cells; a second substrate on the barrier rib and having a surface facing the first substrate; and a plurality of display electrodes extending in a second direction crossing the first direction on the surface of the second substrate. Here, the address electrodes on the first substrate include silver (Ag) and a metal selected from a group consisting of copper (Cu), nickel (Ni), aluminum (Al), and combinations thereof.

In one embodiment, the silver and the metal form an alloy.

In one embodiment, the address electrodes further include a frit attached to the first substrate.

In one embodiment, the silver is formed as silver particles, the metal is formed as metal particles in the address electrodes, and the silver particles are covered with the metal particles. Here, the metal particles may be smaller than the silver particles and may be attached to surfaces of the silver particles, and the address electrodes may further include a frit attached to the first substrate.

Another exemplary embodiment of the present invention provides a plasma display panel that includes a first substrate; a plurality of address electrodes extending in a first direction on the first substrate and covered with a dielectric layer; a barrier rib for partitioning a plurality of discharge cells on the dielectric layer; a plurality of phosphor layers in the discharge cells; a second substrate including sodalime glass, on the barrier rib, and having a surface facing the first substrate, the sodalime glass including Na₂O; and a plurality of display electrodes extending in a second direction crossing the first direction on the surface of the second substrate. Here, the display electrodes on the surface of the second substrate include silver (Ag) and a metal selected from a group consisting of copper (Cu), nickel (Ni), aluminum (Al), and combinations thereof.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective schematic view of a plasma display panel (PDP) according to an exemplary embodiment of the present invention.

FIG. 2 is a cross-sectional schematic view of the plasma display panel taken along line II-II of FIG. 1.

FIG. 3 is a top plan schematic view showing an arrangement of electrodes and discharge cells.

FIG. 4 is a cross-sectional schematic view of the plasma display panel taken along line IV-IV of FIG. 1.

FIG. 5 is a cross-sectional schematic view of an address electrode (or a bus electrode) and a rear substrate (or a front substrate) according to a first exemplary embodiment.

FIG. 6 is a cross-sectional schematic view of an address electrode (or a bus electrode) and a rear substrate (or a front substrate) according to a second exemplary embodiment.

### DETAILED DESCRIPTION OF THE EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween. Like reference numerals designate like elements throughout the specification.

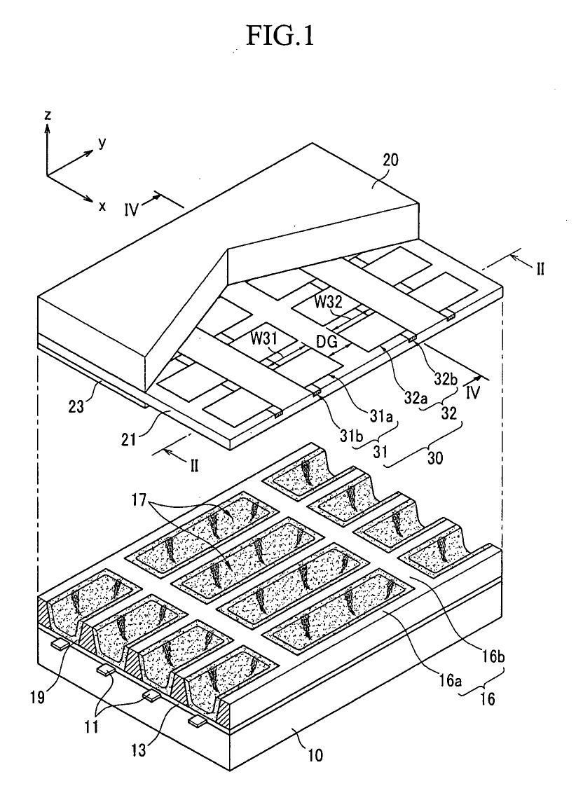

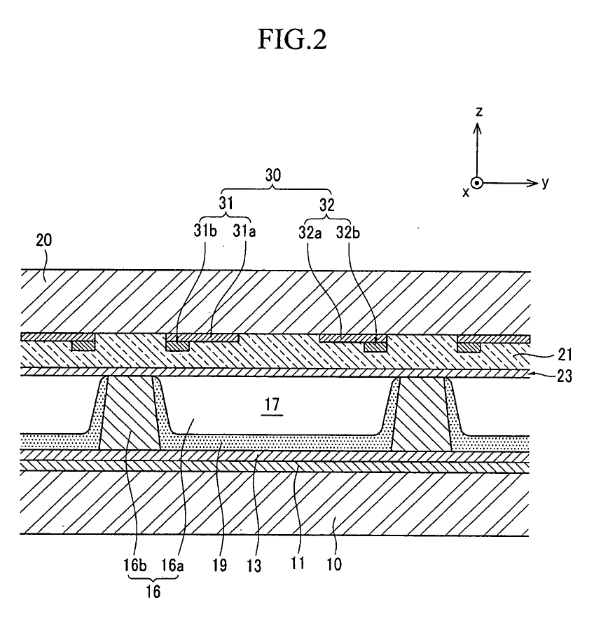

FIG. 1 is an exploded perspective schematic view of a plasma display panel (PDP) according to an exemplary embodiment of the present invention. FIG. 2 is a cross-sectional schematic view of the plasma display panel taken along line II-II of FIG. 1.

Referring to FIG. 1 and FIG. 2, the PDP according to the exemplary embodiment of the present invention includes a first substrate (hereinafter also referred to as “rear substrate”) 10 and a second substrate 20 (hereinafter also referred to as “front substrate”). Here, the rear and front substrates 10 and 20 face each other and are sealed together. A barrier rib 16 is formed between the rear and front substrates 10 and 20.

The barrier rib 16 partitions a plurality of discharge cells 17 between the rear and front substrates 10 and 20. A discharge gas (e.g., a mixed gas of neon (Ne) and xenon (Xe)) is filled in the discharge cells 17 to generate vacuum ultraviolet (VUV) rays by gas discharge. A phosphor layer 19 is formed to absorb the VUV rays to radiate visible light.

To realize an image by the gas discharge, the PDP includes address electrodes 11 and discharge electrodes 30 (hereinafter also referred to as “display electrodes”) that are disposed to correspond to the discharge cell 17 formed between the rear and front substrates 10 and 20.

In the present exemplary embodiment, the display electrodes 30 include first electrodes (hereinafter also referred to as “sustain electrodes”) 31 and second electrodes (hereinafter also referred to as “scan electrodes”) 32 that are formed in pairs.

The rear substrate 10 and the front substrate 20 may be formed of glass substrates including an alkali component. That is, the rear and front substrates 10 and 20 may be formed of sodalime glass including SiO₂—CaO—Na₂O.

In the present exemplary embodiment, one or both of the rear and front substrates 10 and 20 may be formed of sodalime glass. Since the cost of the sodalime glass is low, the manufacturing cost of the PDP can be reduced.

For convenience, both of the rear substrate 10 and the front substrate 20 are formed of the sodalime glass in the present exemplary embodiment. The rear substrate 10 is formed of the sodalime glass, and the address electrodes 11 are formed on an inner surface of the rear substrate 10 (or on a surface of the rear substrate 10 facing the front substrate 20). The front substrate 20 is formed of the sodalime glass, and the display electrodes 30 are formed on an inner surface of the front substrate 20 (or on a surface of the front substrate 20 facing the rear substrate 10).

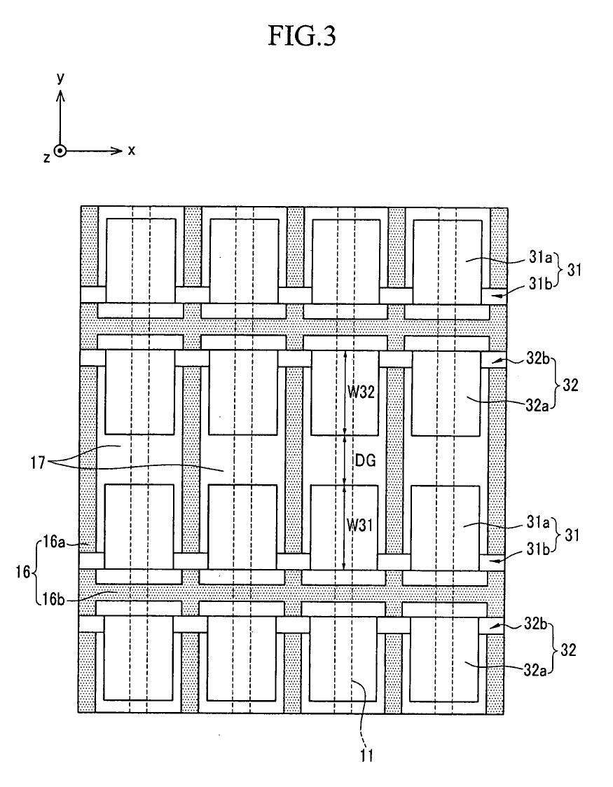

FIG. 3 is a top plan view showing an arrangement of electrodes and discharge cells.

Referring to FIG. 3, one address electrode 11 is formed on an inner surface of the rear substrate 10 while extending along a first direction (i.e., a y-axis direction) to correspond to a line of discharge cells neighboring each other in the y-axis direction. In addition, the plurality of address electrodes 11 are arranged parallel to each other in a second direction (i.e., an x-axis direction) crossing the first direction.

A first dielectric layer 13 covers the address electrodes 11 and the rear substrate 10. The first dielectric layer 13 prevents (or blocks) positive ions or electrons from directly colliding against the address electrodes 11 to reduce a deterioration of the address electrodes 11. In addition, the first dielectric layer 13 provides spaces for forming and accumulating wall charges.

Since the address electrode 11 is disposed on the rear substrate 10, the address electrode 11 may be formed as an opaque electrode because visible light is not prevented from being irradiated forward (or transmitted to the front). That is, the address electrode 11 may be formed as a metal electrode (e.g., an electrode including silver (Ag)) having high electrical conductivity.

The barrier rib 16 is provided on the first dielectric layer 13 to partition the discharge cells 17. For example, the barrier rib 16 includes first barrier rib members 16a extending in the first (or y-axis) direction and second barrier rib members 16b extending between the first barrier rib members 16a in the second (or x-axis) direction to form the discharge cells 17 in a matrix structure.

Further, the barrier rib may be formed as the first barrier rib members extending in the first (or y-axis) direction without the second barrier rib members to form the discharge cells in a stripe pattern. That is, the discharge cells are open along the y-axis direction.

In the exemplary embodiment of the present invention, the barrier rib 16 forming the discharge cells 17 in a matrix structure is provided. When the second barrier rib members 16b are eliminated from the exemplary embodiment, the discharge cells are formed in a stripe pattern by the first barrier rib members 16a. Accordingly, illustration of the discharge cells in the stripe pattern is omitted.

In the respective discharge cells 17, a phosphor paste is coated, dried, and baked on a surface of the first dielectric layer 13 positioned between the barrier ribs 16 and a side surface of the barrier rib 16 to form the phosphor layer 19.

The phosphor layers 19 have the same color phosphor with respect to the discharge cells 17 formed along the y-axis direction. In addition, red R, green G, and blue B phosphors are sequentially formed in the phosphor layers 19 with respect to the discharge cells 17 sequentially disposed along the x-axis direction.

The display electrodes 30 (i.e., the sustain electrodes 31 and the scan electrodes 32) are formed on the inner surface of the front substrate 20 so as to maintain a surface discharge configuration with respect to the respective discharge cells 17. Referring to FIG. 3, one sustain electrode 31 and one scan electrode 32 are formed along the x-axis direction crossing the address electrode 11.

The sustain electrode 31 and the scan electrode 32 respectively include transparent electrodes 31a and 32a for generating discharges, and bus electrodes 31b and 32b for applying a voltage signal to the transparent electrodes 31a and 32a.

The transparent electrodes 31a and 32a generate surface discharges in the discharge cell 17, and are formed of transparent materials (e.g., indium tin oxide (ITO)) to obtain an aperture ratio of the discharge cell 17.

The bus electrodes 31b and 32b are formed of metal materials having high electrical conductivity (for example, silver) to compensate for the high electrical resistance of the transparent electrodes 31a and 32a.

The transparent electrodes 31a and 32a respectively form the surface discharge configuration while having widths W31 and W32 from a contour portion of the discharge cell 17 to a center portion of the discharge cell 17 along the y-axis direction, and a discharge gap DG is formed at a center part of each discharge cell 17.

The bus electrodes 31b and 32b are respectively disposed on the transparent electrodes 31a and 32a, and extend along the x-axis direction at the contour portion of the discharge cell 17. Accordingly, when the voltage signal is applied to the bus electrodes 31b and 32b, the voltage signal is applied to the transparent electrodes 31a and 32a respectively connected to the bus electrodes 31b and 32b.

In addition, as shown in FIG. 1 to FIG. 3, the transparent electrode 31a and 32a may be separately formed to correspond to each discharge cell 17. However, the present invention is not limited thereto. For example, the transparent electrode may be integrally formed along the x-axis direction.

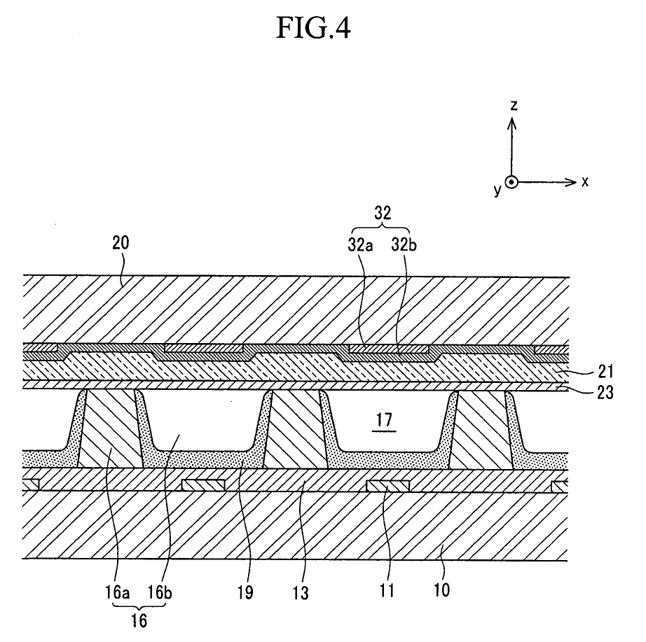

FIG. 4 is a cross-sectional schematic view of the plasma display panel taken along line IV-IV of FIG. 1.

Referring to FIG. 4, when the transparent electrodes 32a are separately formed to correspond to each discharge cell 17, the bus electrodes 32b are formed (or alternatively formed) on the transparent electrodes 32a and the inner surface of the front substrate 20.

A second dielectric layer 21 covers the inner surfaces of the scan electrode 32 and the sustain electrode 31. The second dielectric layer 21 protects the sustain electrode 31 and the scan electrode 32 from the gas discharge, and provides the space for forming and accumulating the wall charges when the discharge is generated.

A protective layer 23 is formed on the second dielectric layer 21 to cover the second dielectric layer 21. For example, the protective layer 23, formed of MgO, protects the second dielectric layer 21, and emits secondary electrons when the discharge is generated.

In the present exemplary embodiment, the rear substrate 10 is formed of sodalime glass, and the address electrodes 11 include silver. Thus, there is a need to suppress a chemical reaction between Na₂O components of the rear substrate 10 and silver components of the address electrodes 11.

In addition, the front substrate 20 is formed of sodalime glass, and the bus electrodes 31b and 32b include silver. Thus, there is a need to suppress a chemical reaction between Na₂O components of the front substrate 20 and silver components of the bus electrodes 31b and 32b.

The structure of the address electrodes 11 formed on rear substrate 10 is the same (or substantially the same) as that of the bus electrodes 31b and 32b formed on the front substrate 20. Accordingly, the structure of the address electrodes 11 formed on the rear substrate 10 will be described in more detail. For clarification purposes, the structure of the bus electrodes 31b and 32b formed on the front substrate 20 will be described in more detail.

FIG. 5 is a cross-sectional view of an address electrode (or a bus electrode) and a rear substrate (or a front substrate) according to a first exemplary embodiment.

Referring to FIG. 5, the address electrodes 11 include silver (Ag) 11a, and a metal, which is not silver. In the present exemplary embodiment, the silver and the metal form an alloy.

For example, the metal 11b is formed of copper (Cu), nickel (Ni) and/or aluminum (Al). Thus, the address electrodes 11 are formed of Ag—Cu, Ag—Ni, and/or Ag—Al alloy.

The silver 11a and the metal 11b of the address electrode 11 are attached on the rear substrate 10 by a frit 11c. In the address electrodes 11, the silver (Ag) 11a is partially separated from Na₂O of the sodalime glass by the metal 11b.

Thus, the chemical reaction between the silver of the address electrodes 11 and the Na₂O of the rear substrate 10 is suppressed. As a result, a migration problem at the rear substrate 10 induced by the chemical reaction can be suppressed, and a short-circuit of the address electrodes 11 and vertical line defects are reduced (or prevented).

In the present exemplary embodiment, the metal 11b is included in the address electrodes 11. Thus, an additional process, such as forming SiO₂, is not needed, and the additional manufacturing cost can be reduced.

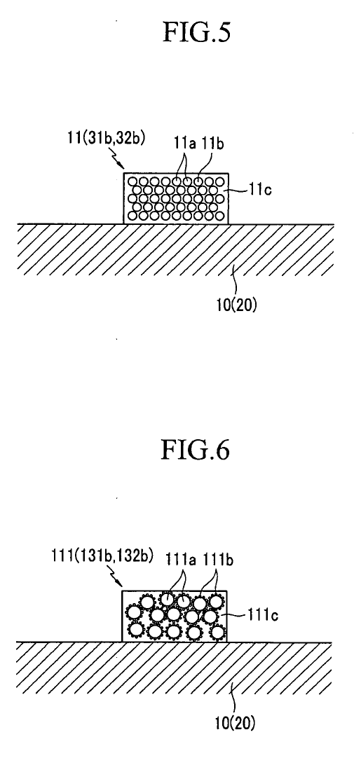

FIG. 6 is a cross-sectional view of an address electrode (or a bus electrode) and a rear substrate (or a front substrate) according to a second exemplary embodiment.

The second exemplary embodiment has the same or similar construction and effect of the first exemplary embodiment. Accordingly, the features of the second exemplary embodiment, which are different from the first exemplary embodiment, will be described in more detail.

Referring to FIG. 6, in address electrodes 111, silver is configured as silver particles 111a, and the metal, which is not silver, is configured as metal particles 111b. The silver particles 111a are covered with the metal particles 111b.

For example, the metal particles 111b are smaller than the silver particles 111a, and are formed of copper (Cu), nickel (Ni) and/or aluminum (Al). Thus, Cu, Ni, and/or Ag particles are attached on (or cover) the silver particles 111a.

The silver particles 111a and the metal particles 111b attached on the silver particles 111a are attached on the rear substrate 10 by a frit 111c. In the address electrodes 111, the silver particles 111a are partially separated from Na₂O of the sodalime glass by the metal particles 111b.

In the present exemplary embodiment, the metal particles 111b attached on the silver particles 111a are included in the address electrodes 111. Thus, an additional process, such as forming SiO₂ thin films, is not needed, and an additional manufacturing cost can be reduced.

The metal 11b is partially in contact with the surface of the silver 11a in the first exemplary embodiment, while the metal particles 111b are in contact with most surface (or substantially all surface) of the silver particles 111a.

Therefore, in the second exemplary embodiment, the silver particles 111a can effectively (or substantially) be separated from the rear substrate 10 by the metal particles 111b, as compared with the first exemplary embodiment.

In the following description, the rear substrate 10 in FIG. 5 will be replaced with the front substrate 20, and the address electrodes 11 in FIG. 5 will be replaced with the bus electrode 31b, 32b, for convenience.

In the bus electrode 31b, 32b, the silver particles 11a are partially separated from Na₂O of the front substrate 20 by the metal particles 11b. The silver 11a of the bus electrode 31b, 32b is partially separated from the Na₂O of the sodalime glass, and thus the migration generated by the chemical reaction between them is suppressed.

As a result, the chemical reaction between the silver of the bus electrode 31b, 32b and the Na₂O of the front substrate 20 is suppressed. Accordingly, the change of the color of the front substrate 20 is suppressed, and the yellowing is reduced (or prevented).

In the following description, the rear substrate 10 in FIG. 6 will be replaced with the front substrate 20, and the address electrodes 111 in FIG. 6 will be replaced with a bus electrode 131b, 132b, for convenience.

In the bus electrode 131b, 132b, the silver particles 111a are partially separated from Na₂O of the front substrate 20 by the metal particles 111b attached on the silver particles. The silver particles 111a of the bus electrode 131b, 132b are partially separated from the Na₂O of the sodalime glass, and thus a migration problem generated by the chemical reaction between them is suppressed.

The metal 11b is partially in contact with the surface of the silver 11a in the first exemplary embodiment, while the metal particles 111b are in contact with the most surface (or substantially all surface) of the silver particles 111a.

Therefore, in the second exemplary embodiment, the silver particles 111a can effectively (or substantially) be separated from the front substrate 10 by the metal particles 111b, as compared with the first exemplary embodiment.

Referring back to FIG. 1 and FIG. 2, when the PDP is driven, a reset discharge is generated by a reset pulse applied to the scan electrode 32 during a reset period. An address discharge is generated by an address pulse applied to the address electrode 11 and a scan pulse applied to the scan electrode 32 during a scan period (or address period) that is subsequent to the reset period. Subsequently, during a sustain period, a sustain discharge is generated by a sustain pulse applied to the sustain electrode 31 and the scan electrode 32.

The sustain pulse is used to generate the sustain discharge and is applied to the sustain electrode 31 and the scan electrode 32. The reset pulse and the scan pulse are applied to the scan electrode 32. The address pulse is applied to the address electrode 11.

Since functions of the sustain electrode 31, the scan electrode 32, and the address electrode 11 may vary according to applied voltage waveforms, they are not limited thereto.

The PDP selectively turns on/off discharge cells 17 by the address discharge caused by a reciprocal action between the address electrode 11 and the scan electrode 32, and realizes an image by the sustain discharge caused by a reciprocal action between the sustain electrode 31 and the scan electrode 32 in the selected discharge cells 17.

As the above, in the plasma display panel according to an exemplary embodiment of the present invention, the electrodes formed on the sodalime glass substrate including Na₂O include silver and a metal, which is not silver. Thus, the migration generated by the chemical reaction between the Na₂O components and the silver components can be suppressed.

According to a plasma display panel of an exemplary embodiment of the present invention, a sodalime glass is used as a rear substrate and an address electrode includes silver and a metal, which is not silver. Thus, the migration generated by the chemical reaction between the Na₂O components of the rear substrate and the silver components of the address electrode can be suppressed. Accordingly, the vertical line defects induced by a short-circuit of the address electrodes can be reduced (or prevented).

According to a plasma display panel of an exemplary embodiment of the present invention, a sodalime glass is used as a front substrate and a bus electrode includes silver and a metal, which is not silver. Thus, the migration generated by the chemical reaction between the Na₂O components of the front substrate and the silver components of the bus electrode can be suppressed. Therefore, the color change of the front substrate and the yellowing of the front substrate can be reduced (or prevented).

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel comprising:
a first substrate;
a second substrate facing the first substrate;
a barrier rib between the first substrate and the second substrate to partition a plurality of discharge cells;
a plurality of phosphor layers in the discharge cells;
a plurality of address electrodes extending in a first direction on the first substrate; and
a plurality of display electrodes extending in a second direction crossing the first direction on the second substrate,
wherein at least one substrate of the first substrate or the second substrate comprises sodalime glass including Na₂O, and
wherein at least one electrode of the address electrodes or the display electrodes on the at least one substrate comprises silver (Ag) and a metal selected from a group consisting of copper (Cu), nickel (Ni), aluminum (Al), and combinations thereof.

2. The plasma display panel of claim 1, wherein the silver and the metal form an alloy.

3. The plasma display panel of claim 1, wherein the at least one electrode further comprises a frit attached to the at least one substrate.

4. The plasma display panel of claim 1, wherein the silver is formed as silver particles, wherein the metal is formed as metal particles in the at least one electrode, and wherein the silver particles are covered with the metal particles.

5. The plasma display panel of claim 4, wherein the metal particles are smaller than the silver particles and are attached to surfaces of the silver particles, and wherein the at least one electrode further comprises a frit attached to the at least one substrate.

6. A plasma display panel comprising:
a first substrate comprising sodalime glass, the sodalime glass including Na₂O;
a plurality of address electrodes extending in a first direction on the first substrate and covered with a dielectric layer;
a barrier rib for partitioning a plurality of discharge cells on the dielectric layer;
a plurality of phosphor layers in the discharge cells;
a second substrate on the barrier rib and having a surface facing the first substrate; and
a plurality of display electrodes extending in a second direction crossing the first direction on the surface of the second substrate,
wherein the address electrodes on the first substrate comprise silver (Ag) and a metal selected from a group consisting of copper (Cu), nickel (Ni), aluminum (Al), and combinations thereof.

7. The plasma display panel of claim 6, wherein the silver and the metal form an alloy.

8. The plasma display panel of claim 6, wherein the address electrodes further comprise a frit attached to the first substrate.

9. The plasma display panel of claim 6, wherein the silver is formed as silver particles, wherein the metal is formed as metal particles in the address electrodes, and wherein the silver particles are covered with the metal particles.

10. The plasma display panel of claim 9, wherein the metal particles are smaller than the silver particles and are attached to surfaces of the silver particles, and wherein the address electrodes further comprise a frit attached to the first substrate.

11. A plasma display panel comprising:
a first substrate;
a plurality of address electrodes extending in a first direction on the first substrate and covered with a dielectric layer;
a barrier rib for partitioning a plurality of discharge cells on the dielectric layer;
a plurality of phosphor layers in the discharge cells;
a second substrate comprising sodalime glass, on the barrier rib, and having a surface facing the first substrate, the sodalime glass including Na₂O; and
a plurality of display electrodes extending in a second direction crossing the first direction on the surface of the second substrate,
wherein the display electrodes on the surface of the second substrate comprise silver (Ag) and a metal selected from a group consisting of copper (Cu), nickel (Ni), aluminum (Al), and combinations thereof.

12. The plasma display panel of claim 11, wherein the silver and the metal form an alloy.

13. The plasma display panel of claim 11, wherein the display electrodes further comprise a frit attached to the second substrate.

14. The plasma display panel of claim 11, wherein the silver is formed as silver particles, wherein the metal is formed as metal particles in the display electrodes, and wherein the silver particles are covered with the metal particles.

15. The plasma display panel of claim 14, wherein the metal particles are smaller than the silver particles and are attached to surfaces of the silver particles, and wherein the display electrodes further comprise a frit attached to the second substrate.

16. The plasma display panel of claim 11, wherein the display electrodes comprise transparent electrodes and bus electrodes, and wherein the bus electrodes comprise silver (Ag) and a metal selected from a group consisting of copper (Cu), nickel (Ni), aluminum (Al), and combinations thereof.

17. The plasma display panel of claim 16, wherein the silver and the metal form an alloy.

18. The plasma display panel of claim 16, wherein the bus electrodes further comprise a frit attached to the second substrate.

19. The plasma display panel of claim 16, wherein the silver is formed as silver particles, wherein the metal is formed as metal particles in the bus electrodes, and wherein the silver particles are covered with the metal particles.

20. The plasma display panel of claim 19, wherein the metal particles are smaller than the silver particles and are attached to surfaces of the silver particles, and wherein the bus electrodes further comprise a frit attached to the second substrate.
